(19) United States
(12) Patent Application Publication
(10) Pub. No.: US 2026/0346793 A1
(43) Pub. Date: Nov. 5, 2026

(54) ALL TERRAIN VEHICLE/UTILITY TASK VEHICLE REAR LOADER

(71) Applicant: Robert Stillwagon, Normalville, PA (US)

(72) Inventor: Robert Stillwagon, Normalville, PA (US)

(21) Appl. No.: 19/198,671

(22) Filed: May 5, 2025

(51) Int. Cl. B60R 9/06

(52) U.S. Cl. CPC B60R 9/06

(57) ABSTRACT

A rear loader basket for an ATV/UTV (all terrain vehicle, utility task vehicle) including a basket comprising a hinge bar, a hinge back, a bottom, a scoup front and two pulley sides each comprising a pulley wheel adjoining the bottom and the scoup front. The disclosure also includes a pulley bar comprising a pulley wheel on each of two ends of the pulley bar and adjoining each of the two pulley sides via a pulley cable on each side between a pulley wheel of the pulley bar and a respective pulley side wheel. The disclosure further includes a winch configured to pull the basket from a loading position to a storage position via the pulley cable, the pulley bar and the pulley wheels of the two pulley sides.

### SUMMARY OF THE INVENTION

A loader basket for an ATV/UTV (all terrain vehicle, utility task vehicle) including a basket comprising a hinge bar, a hinge back, a bottom, a scoup front and two pulley sides each comprising a pulley wheel adjoining the bottom and the scoup front. The loader basket is affixed to a front end of an ATV/UTV or a back end or both. The disclosure also includes a pulley bar comprising a pulley wheel on each of two ends of the pulley bar and adjoining each of the two pulley sides via a pulley cable on each side between a pulley wheel of the pulley bar and a respective pulley side wheel. The disclosure further includes a winch configured to pull the basket from a loading position to a storage position via the pulley cable, the pulley bar and the pulley wheels of the two pulley sides.

### BRIEF DESCRIPTION OF THE DRAWINGS

FIG. 1 shows the ATV/UTV Rear Loader in a loading position in accordance with an embodiment of the present disclosure.

FIG. 2 shows the ATV/UTV Rear Loader in a storage position in accordance with an embodiment of the present disclosure.

The description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

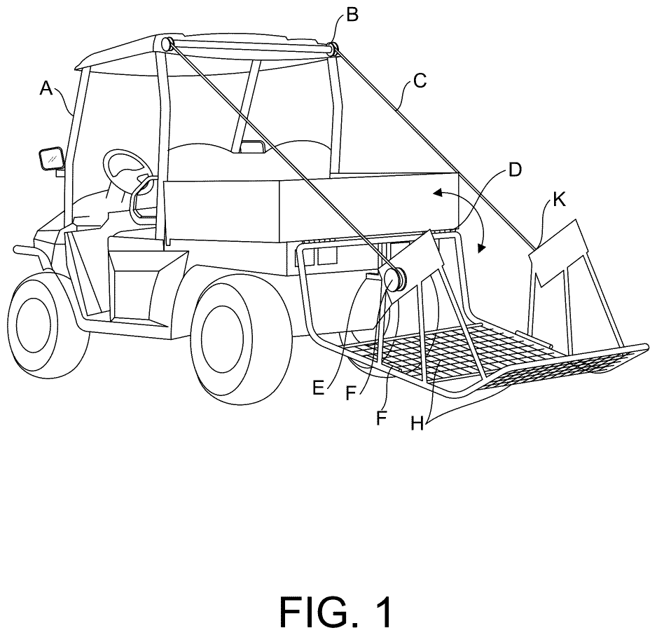

FIG. 1 shows the ATV/UTV Rear Loader in a loading position in accordance with an embodiment of the present disclosure. The depiction includes the UTV or ATV (All Terain Vehicle) A, the pulley bar B, the cable C, the hinges D, the receiver hitch E, the winch F, the springs G and the folding rack. The front side of the rack is able to extend all the way to the ground in embodiments to enhance loadability.

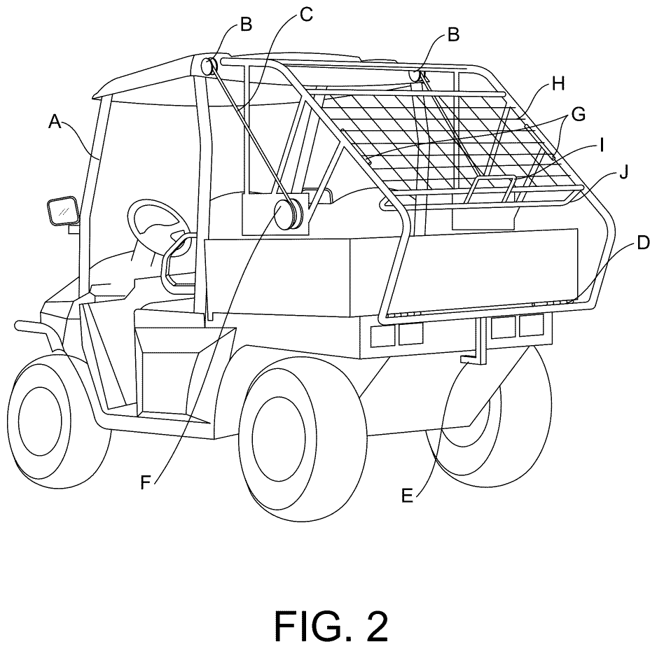

FIG. 2 shows the ATV/UTV Rear Loader in a storage position in accordance with an embodiment of the present disclosure. The depiction includes most of the limitations of FIG. 1 with the addition of the drop bar J and the support bar I which acts as a handle. The drop bar J acts as a limiter to a storage configuration of the disclosure against a back side of the ATV/UTV against a seat back and other rear end structures. The double headed arrows indicate a swinging motion of the disclosure around the hinge pivots from loading to storage positions.

The disclosure is specifically designed to simplify the process of loading and unloading heavy objects into a bed of an ATV/UTV Utility Task Vehicle. In many outdoor and work-related environments, users often need to transport bulky or heavy items, which can pose significant physical challenges. One aim of the disclosure is to provide a safe and an efficient solution for these tasks, allowing users to lift and transport materials with minimal physical strain. This is particularly helpful in settings such as construction sites, farms, and recreational activities where heavy lifting is common. By addressing the need for easier loading, the disclosure enhances productivity while reducing the risk of injury associated with manual lifting.

Hinges play a crucial role in the loader's functionality, allowing it to fold/store and unfold/load easily while maintaining structural integrity. This pivoting mechanism is essential for transforming from a compact storage state to an operational state. The receiver hitch serves as the attachment point for the loader to the ATV/UTV, ensuring a stable connection that can withstand the forces generated during lifting.

The winch, available in both hand crank and electric options, provides the heavy lifting mechanism, providing the necessary power to elevate heavy items into the ATV/UTV bed. Springs are integrated into the design to assist in lifting the loader itself, effectively reducing the effort required by the user and preventing abrupt descents that could lead to accidents.

Lastly, the folding rack provides a sturdy platform for holding loads, yet can be coveniently folded away when not in use, maximizing storage space and maintaining a clutter free environment and even providing an airy and protective backside to any ATV/UTV. The disclosure addresses several key challenges that users face when dealing with heavy loads. One of the most significant benefits is the reduction of physical strain involved in lifting heavy objects. Many individuals risk injury from repetitive lifting, especially in outdoor settings where conditions can bee unpredictable. By utilizing the disclosure, users can significantly lower the risk of back injuries and other musculoskeletal problems leading to a safer working environment.

In addition to improving safety, the disclosure streamlines the loading process itself. Traditional methods of loading heavy items can be time consuming and inefficient, often requiring multiple people or complicated maneuvers. The disclosure allows users to quickly and efficiently lift and to transport materials, making it particularly valuable in time sensitive situations where efficiency is paramount.

Furthermore, the loader's adjustable design means it can accommodate various ATV/UTV models, ensuring versatility across different vehicles. This adaptability makes it an appealing option for a wide range of users, from farmers and contractors to outdoor enthusiasts. The disclosure not only ensures stability and safety during operation but also folds away for compact storage, saving space when not in use. In summary, it enhances the utility and functionality of ATVs/UTVs, transforming them into powerful tools for transporting heavy loads, thereby making it an essential addition for those who rely on their vehicles for heavy-duty tasks.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A loader basket for an ATV/UTV (all terrain vehicle/utility task vehicle) comprising: a basket comprising a hinge bar, a hinge back, a bottom, a scoup front and two pulley sides each comprising a pulley wheel adjoining the bottom and the scoup front; a pulley bar comprising a pulley wheel on each of two ends of the pulley bar and adjoining each of the two pulley sides via a pulley cable on each side between a pulley wheel of the pulley bar and a respective pulley side wheel; a winch configured to pull the basket from a loading position to a storage position via the pulley cable, the pulley bar and the pulley wheels of the two pulley sides.

2. The loader basket of claim 1, wherein the winch is disposed on the pulley bar.

3. The loader basket of claim 1, wherein the winch is disposed on of the pulley side wheels.

4. The loader basket of claim 1, wherein the winch is disposed on each of the pulley side wheels.

5. The loader basket of claim 1, further comprising a support bar which also acts as a handle.

6. The loader basket of claim 1, further comprising a drop bar configured to limit a rotational travel of the loader basket onto a back of the ATV/UTV.

7. The loader basket of claim 1, wherein the hinge bar is configured to rotate perpendicular to the receiver hitch.

8. The loader basket of claim 1, further comprising a spring disposed on the hinge bar configured to retard a movement of the loader basket relative to the UTV/ATV.

9. The loader basket of claim 1, wherein the bottom and the front side comprise a mesh.

10. The loader basket of claim 1, wherein the bottom joins the hinge back and the scoup front at obtuse angles.

11. The loader basket of claim 1, wherein the loader basket travels more than one hundred and eighty degrees from a loading position to a storage position.

12. The loader basket of claim 1, wherein the scoup front comprises a metal plate to act as a loading ramp and to act as a roof when loaded.

13. The loader basket of claim 1, wherein the hinge back is open for loaded visibility of the UTV/ATV tail lights and brake lights.

14. The loader basket of claim 1, wherein the hinges are mounted to a bumper of the UTV/ATV.

15. The loader basket of claim 1, wherein the two pulley sides are free-standing with respect to the hinge back.
